(19) United States
(12) Patent Application Publication
(10) Pub. No.: US 2020/0334612 A1
(43) Pub. Date: Oct. 22, 2020

(54) SYSTEMS AND METHODS FOR PROVIDING COMMUNICATION BETWEEN USER INTERFACES OF QUICK SERVICE RESTAURANTS

(71) Applicant: HM ELECTRONICS, INC., Poway, CA (US)

(72) Inventors: James Thomas Silane, San Diego, CA (US); David Kenneth Mattox, Temecula, CA (US)

(21) Appl. No.: 16/385,576

(22) Filed: Apr. 16, 2019

(51) Int. Cl. G06Q 10/06; G06F 9/451; G06F 9/54

(52) U.S. Cl. CPC G06Q 10/06393; G06Q 10/06395; G06Q 50/12; G06F 9/451; G06F 9/542; G06Q 10/063114

(57) ABSTRACT

Systems and methods for providing communication between user interfaces of quick service restaurants are disclosed. Exemplary implementations may: obtain sets of values of a service metric that is related to service durations at the quick service restaurants; effectuate a first presentation on the first user interface of a representation of a ranking order of the quick service restaurants based on the obtained values; receive, through entry and/or selection by the first user, a first message intended to be included in a second presentation on the second user interface of a second quick service restaurant, wherein one or both of the content of the first message and/or the timing of the second presentation (that includes the first message) represent a comment on and/or a reaction to the first presentation; transfer the first message to the second user interface; and effectuate the second presentation on the second user interface.

### FIELD OF THE DISCLOSURE

The present disclosure relates to systems and methods for providing communication between user interfaces of quick service restaurants.

### BACKGROUND

Quick service restaurants are known. Measuring how long it takes to provide service to individual customers at quick service restaurants is known. Comparing performance measurements between, e.g., employees, is known.

### SUMMARY

One aspect of the present disclosure relates to a system configured for providing communication between user interfaces of quick service restaurants. The quick service restaurants may include a first and a second quick service restaurant. The user interfaces may include a first user interface associated with the first quick service restaurant and a second user interface associated with the second quick service restaurant. The system may include one or more hardware processors configured by machine-readable instructions. The processor(s) may be configured to obtain sets of values of a service metric that is related to service durations at the quick service restaurants. The sets of values may be used to determine a ranking order of the quick service restaurants during a time-limited event. The processor(s) may be configured to effectuate a first presentation on the first user interface of a representation of the ranking order of the quick service restaurants. The processor(s) may be configured to receive, through entry and/or selection by the first user, a first message intended to be included in a second presentation on the second user interface. One or both of the content of the first message and/or the timing of the second presentation that includes the first message may represent a comment on and/or a reaction to the first presentation. The processor(s) may be configured to transfer the first message to the second user interface, thereby effectuating the second presentation on the second user interface. The second presentation may include information based on the first message.

Another aspect of the present disclosure relates to a method for providing communication between user interfaces of quick service restaurants. The quick service restaurants may include a first and a second quick service restaurant. The user interfaces may include a first user interface associated with the first quick service restaurant and a second user interface associated with the second quick service restaurant. The method may include obtaining sets of values of a service metric that is related to service durations at the quick service restaurants. The sets of values may be used to determine a ranking order of the quick service restaurants during a time-limited event. The method may include effectuating a first presentation on the first user interface of a representation of the ranking order of the quick service restaurants. The method may include receiving, through entry and/or selection by the first user, a first message intended to be included in a second presentation on the second user interface. One or both of the content of the first message and/or the timing of the second presentation that includes the first message may represent a comment on and/or a reaction to the first presentation. The method may include transferring the first message to the second user interface, thereby effectuating the second presentation on the second user interface. The second presentation may include information based on the first message.

As used herein, any association (or relation, or reflection, or indication, or correspondency) involving servers, processors, client computing platforms, timing information, service durations, events, times, dates, contests, participants, service metrics, values for service metrics, ranking orders, user interfaces, presentations, representations, durations, completions, indicators, indications, persons, vehicles, results, awards, notifications, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing communication between user interfaces of quick service restaurants, in accordance with one or more implementations.

FIG. 2 illustrates a method for providing communication between user interfaces of quick service restaurants, in accordance with one or more implementations.

FIG. 3 illustrates an exemplary user interface as may be provided to employees of a quick service restaurant after an event has been initiated as described in this disclosure, in accordance with one or more implementations.

FIG. 4 and FIG. 5 illustrate exemplary user interfaces as may be provided to employees of a quick service restaurant as described in this disclosure, in accordance with one or more implementations.

FIG. 6 illustrates an exemplary user interface as may be presented when a quick service restaurant has won an award in an event, as described in this disclosure.

FIG. 7 illustrates an exemplary user interface for a user to initiate events to challenge another quick service restaurant, in accordance with one or more implementations.

FIG. 8 illustrates an exemplary user interface as may be provided to create a message intended to be included in a particular presentation on a particular user interface, in accordance with one or more implementations.

FIG. 9 illustrates an exemplary user interface as may be presented to provide communication between quick service restaurants, in accordance with one or more implementations.

### DETAILED DESCRIPTION

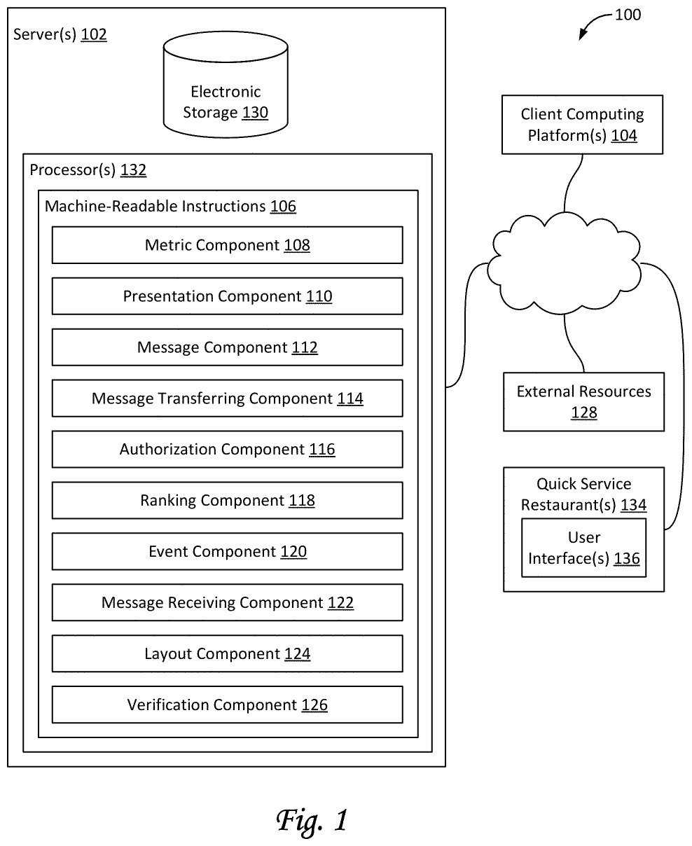

FIG. 1 illustrates a system 100 configured for providing communication between user interfaces 136 of quick service restaurants 134, in accordance with one or more implementations. Quick service restaurants 134 may include a first quick service restaurant, a second quick service restaurant, a third quick service restaurant, and so forth. User interfaces 136 may include a first user interface associated with the first quick service restaurant, a second user interface associated with the second quick service restaurant, a third user interface associated with the third quick service restaurant, and so forth. The first user interface may be configured to present information to the employees of the first quick service restaurant. The presented information may include information about service metrics and/or other performance indicators pertaining to the operation of the first quick service restaurant. Additionally, the presented information may include external information about external service metrics and/or other external performance indicators pertaining to the operation of other quick service restaurants. For example, the first user interface could present a ranking of the total number of customers served this week, month, or year, for multiple quick service restaurants 134. In some implementations, such a presentation may be referred to as a leaderboard.

In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104, one or more user interfaces 136, and/or other components of system 100.

Server(s) 102 may be configured by machine-readable instructions 106. Machine-readable instructions 106 may include one or more instruction components. The instruction components may include computer program components. The instruction components may include one or more of metric component 108, presentation component 110, message component 112, message transferring component 114, authorization component 116, ranking component 118, event component 120, message receiving component 122, layout component 124, verification component 126, and/or other instruction components.

Metric component 108 may be configured to determine and/or obtain sets of values of service metrics. In some implementations, one or more service metrics may be related to service durations at quick service restaurants 134. The sets of values may be used to determine a ranking order of quick service restaurants 134, e.g., during a time-limited event. In some implementations, service metrics may be based on service timing information. In some implementations, service metrics and/or service timing information may be based on service durations for individual instances of service being provided at quick service restaurants 134. For example, metric component 108 may locally determine a set of values of a service metric for a first quick service restaurant and obtain one or more sets of values of external service metrics for other quick service restaurants, such as the second and third quick service restaurants. From the point of view of the first quick service restaurant, the other quick service restaurants (and their values for any service metrics) are external. Likewise, from the point of view of the second quick service restaurant, the service metrics of the first and third quick service restaurants are external.

Individual service durations may be defined by the time between a service start time and a service stop time. In some implementations, an individual quick service restaurant 134 may be a drive-thru restaurant. In some implementations, the service start time may be defined as the moment a particular vehicle enters the drive-thru (e.g., passes a particular point on the road surface of the drive-thru). In some implementations, the service start time may be defined as the moment people in the particular vehicle begin or complete their order, or pay for their order. In some implementations, the service stop time of a service duration may be defined as the moment particular vehicle exits the drive-thru (e.g., passes a particular point on the road surface of the drive-thru). In some implementations, the service stop time may be defined as the moment people in a particular vehicle receive their order, or pay for their order. Service start times and service stop times for different customers may be interleaved, such that individual service durations partially overlap with other service durations. Service durations may include a first service duration, a second service duration, a third service duration, and so forth. Vehicles may include a first vehicle, a second vehicle, a third vehicle, and so forth. In some implementations, individual instances of service being provided at a particular quick service restaurant 134 may include a first instance of service being provided to a first person in the first vehicle, a second instance of service being provided to one or more people in the second vehicle, and so forth.

In some implementations, determining the values of one or more service metrics may be performed (e.g., locally by individual quick service restaurants) during a time-limited event, during a predetermined time period, at the completion of a time-limited event, and/or at the completion of a predetermined time period. For example, the average service duration per instance of service being provided at a quick service restaurant 134 for a first contest (described elsewhere) may be determined by adding any service durations for instances of service provided on a Friday between 11 a.m. and 2 p.m., and dividing this total duration by the number of these instances. In some implementations, the values of one or more service metrics may be used as a basis for determining a performance level of a particular quick service restaurant. For example, performance levels may be determined at any time, including times when no events are ongoing.

By way of non-limiting example, a time-limited event may be characterized by event timing information, event participant information, event objective information for the time-limited event, and/or other information related to the time-limited event. In some implementations, events may include one or more contests, challenges, and/or other competitions. In some implementations, a time-limited event may be configured and/or initiated by event component 120. In some implementations, for example, an employee at a first quick service restaurant (such as a manager or other authorized user) may issue a challenge to (the employees of) a second quick service restaurant. The events may include a first event, a second event, a third event, and so forth.

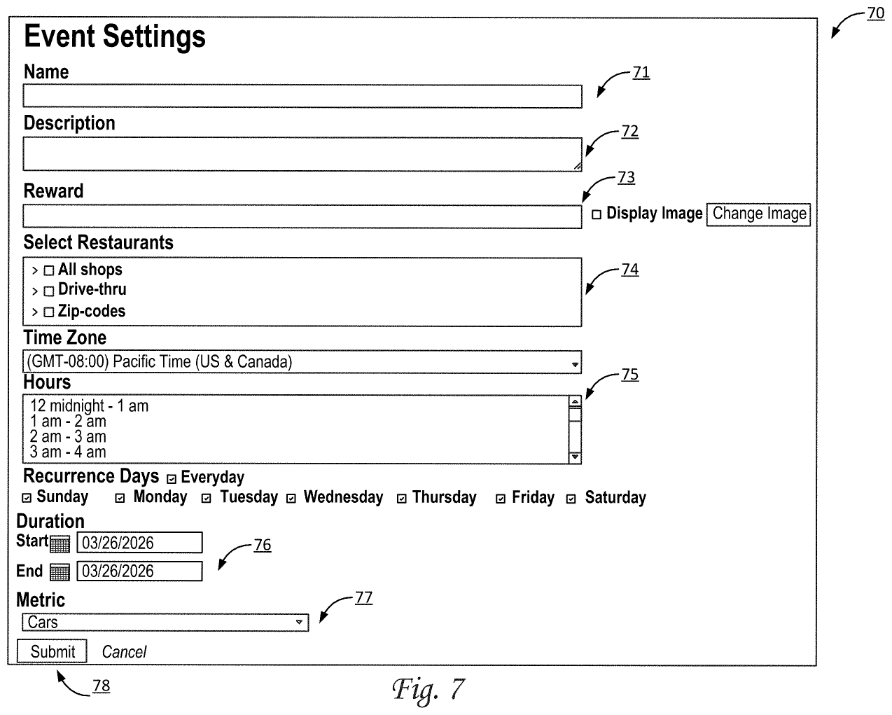

By way of non-limiting example, FIG. 7 illustrates an exemplary user interface 70 for an employee (e.g., an authorized user) to initiating an event as a challenge to another quick service restaurant. As depicted, event information may be received, through entry and/or selection by a user via exemplary user interface 70. As depicted, element 71 and element 72 may be used to provide a name and description for a new event. Element 73 may be used to describe or select an award for the new event. Element 74 may be used to provide event participant information. Element 75 may be used to provide an event start time and an event stop time. Element 76 may be sued to provide an event start date and an event end date. Element 77 may be used to provide one or more service metrics to be used for ranking associated with the new event. Element 78 may be used to submit, initiate, launch, and/or otherwise start the new event as specified (or issue a challenge to start this event) though user interface 70.

Referring to FIG. 1, event timing information may specify an event start time and an event stop time for the time-limited event, thereby defining an event duration between the event start time and the event stop time. In some implementations, the event timing information may specify an event start date and/or an event stop date, thereby defining an event date range. The first event may be associated with a first event duration, the second event may be associated with the second event duration, the third event may be associated with the third event duration, and so forth. In some implementations, the event duration may be defined as a duration between 2 and 4 hours.

Event participant information may identify individual quick service restaurants participating in the time-limited event. For example, a first event may have the first and second quick service restaurants as participants, a second event may have the second and third quick service restaurants as participants, and the third event may have the first and third restaurants as participants. In some implementations, a particular event may include multiple quick service restaurants 134 that are operated by the same franchisee, located in the same geographical region, owned by the same owner, and/or otherwise have one or more characteristics in common.

Event objective information may specify one or more service metrics on which the individual quick service restaurants are competing during a particular time-limited event. By way of non-limiting example, the one or more service metrics may include one or more of average service duration per instance of service being provided at an individual quick service restaurant, percentage of the instances of service being provided for which the service duration is at or below a service duration goal, number of instances of service being provided at an individual quick service restaurant, and/or percentage reached of a goal number of instances of service being provided at an individual quick service restaurant. In some implementations, one or more service metrics may be based (at least in part) on information from the one or more points-of-sale (e.g., total sales, average sales per instance of service, etc.). Service metrics that combine service duration and information from a point-of-sale (POS) are envisioned within the scope of this disclosure.

Event component 120 may configure and/or initiate the time-limited event. Configuring and/or initiating the time-limited event may include receiving event information through entry and/or selection by the first user, e.g., via the first user interface. In some implementations, individual events may span multiple days. For example, a particular event may last a week, a month, or another multi-day period. In some implementations, a particular event may include individual rounds of competition occurring on different days. For example, a first contest may span every Friday from 11 a.m. to 2 p.m. for 3 months. For example, a second contest may span every Monday through Thursday from 6 a.m. to 10 a.m. for 2 months. For example, a third contest may span every Saturday and Sunday from 9 a.m. to 11 a.m., between an event start date and an event stop date that are about 10 weeks apart. In these examples, the portion of the contest that falls on a single day may be referred to as a round, or a daily round.

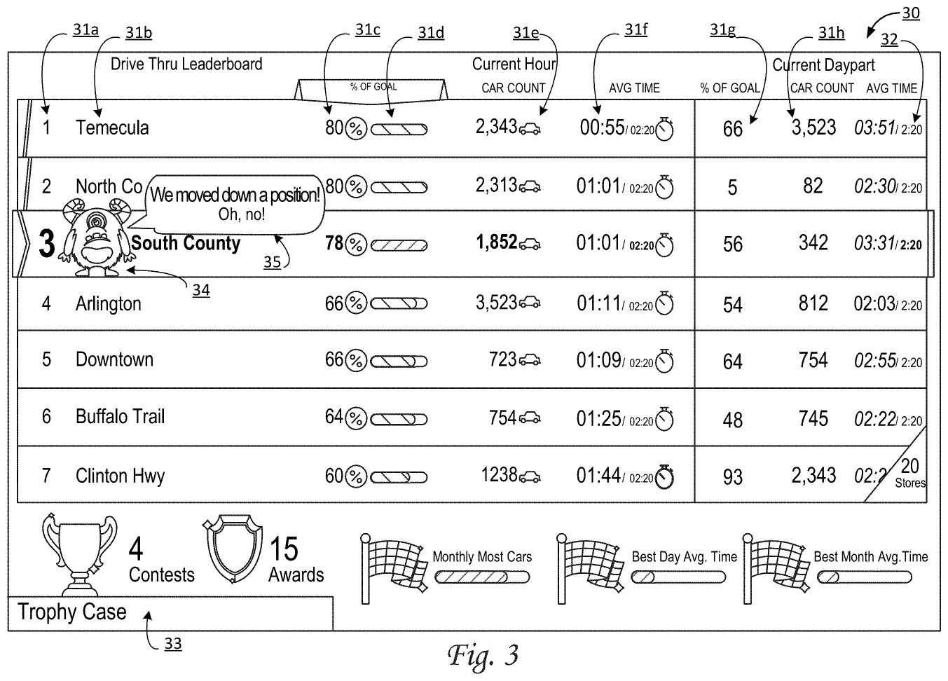

By way of non-limiting example, FIG. 3 illustrates an exemplary user interface 30 as may be presented to an individual quick service restaurant upon initiation of an event as described in this disclosure. As depicted in user interface 30, information related to an individual quick service restaurant is presented horizontally in a row. Each row includes values of service metrics and/or information derived therefrom. For example, an element 31a depicts a ranking in a ranking order. An element 31b depicts a name or identifier of an individual quick service restaurant. An element 31c depicts a service metric for the percentage of the instances of service being provided for which the service duration is at or below a service duration goal. Depending on whether the nature of the goal is a minimum or a maximum quantity, meeting a goal may be defined as reaching a metric and/or result that is below the goal, at or below the goal, at the goal, at or above the goal, or above the goal. An element 31d depicts a progress bar related to a service metric goal. An element 31e depicts the number of instances of service that have been provided at the quick service restaurant. An element 31f depicts an average service duration per instance of service being provided at the quick service restaurant (next to a service duration goal). An element 31g depicts a service metric for the percentage of the instances of service being provided for which the service duration is at or below a service duration goal. An element 31h depicts the number of instances of service that have been provided at the quick service restaurant. An element 32 depicts an average service duration per instance of service being provided at the quick service restaurant (next to a service duration goal). Elements 31c, 31d, 31e, and 31f may be associated with a particular time period or duration, such as, e.g., a current hour. Elements 31g, 31h, and 32 may be associated with a different time period or duration, such as, e.g., a current daypart. An element 33 depicts a trophy case for the “South County” quick service restaurant, which has ranking 3. For example, the quick service restaurant identified as “Temecula” is currently in first place, and “North County” is in second place, based on the values for the particular service metric being used to determine the ranking order. User interface 30 may be associated with the “South County” quick service restaurant, as is visually indicated by, e.g., the font size used for ranking element 31a in the depicted ranking order. An individual quick service restaurant may be associated with an avatar or character, here depicted as avatar 34. The information presented in each row may depict the current status of an event or contest. For example, information 35 may be depicted subsequent to a change in the ranking order (here, “South County” moved down from ranking second to ranking third). Information 35 may include context-specific feedback provided in real-time (or with minimum delay), which may be based on a change in value of one or more service metrics. Here, information 35 may be based on the relative ranking order for multiple quick service restaurants. The number of rows and columns depicted is exemplary and not intended to be limiting in any way.

Ranking component 118 may be configured to determine a ranking order of quick service restaurants 134, e.g., during a time-limited event. Determination by ranking component 118 may be based on sets of values determined and/or obtained by metric component 108. In some implementations, determination of the ranking order may be performed dynamically on an on-going basis, e.g., throughout the event duration. A representation of the ranking order (e.g., as presented by presentation component 110) may be updated dynamically and on an ongoing basis such that at most 5 minutes pass between occurrence of a new service duration at the first restaurant and an update to the first presentation. In some implementations, ranking component 118 may be configured to determine event-specific results subsequent to completion of a particular event and/or a round of a particular event, e.g., through aggregation, averaging, derivations, etc. In some implementations, the completion of a particular event may occur on the event stop date at the event stop time. In some implementations, the completion of a particular daily round of an event may occur at the event stop time within the event date range, on those days the daily rounds are held.

Presentation component 110 may be configured to effectuate presentations on user interfaces 136 of quick service restaurants 134. For example, presentation component 110 may present a first presentation on the first user interface of a representation of the ranking order of quick service restaurants 134. In some implementations, presentation component 110 may present a second presentation on the second user interface of the second quick service restaurant. In some implementations, presentation component 110 may present a third presentation on the third user interface of the third quick service restaurant. In some implementations, the second presentation may include information based on a message (which may be initiated by the first user) from message component 112, message transferring component 114, and/or another component of system 100. In some implementations, the third presentation may include information based on a second message (which may be initiated by the second user) from message component 112, message transferring component 114, and/or another component of system 100.

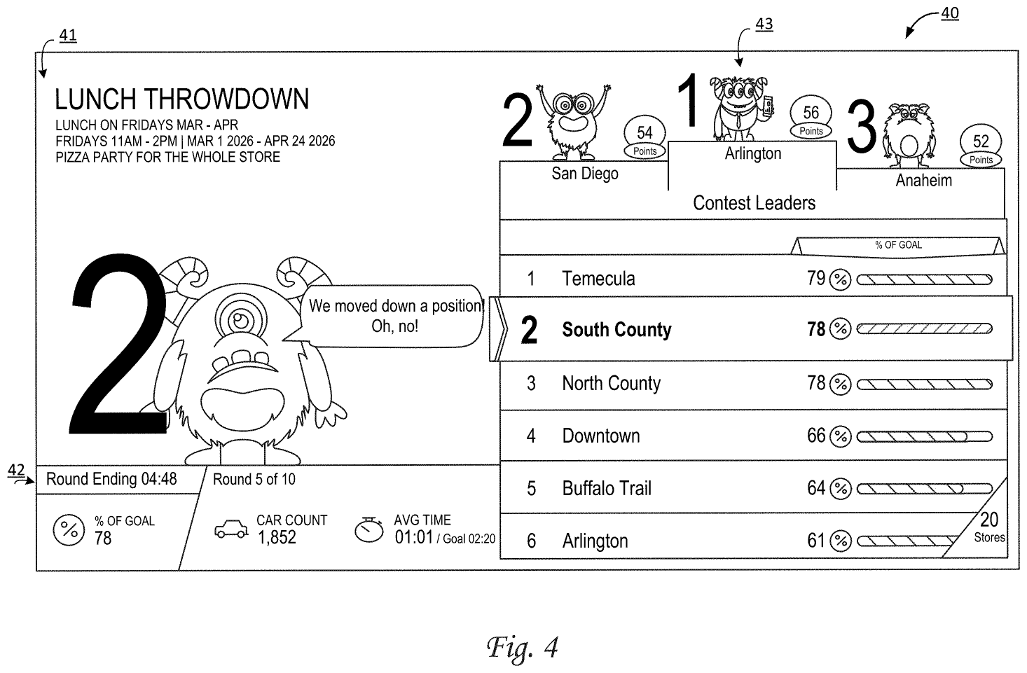

By way of non-limiting example, FIG. 4 illustrates an exemplary user interface 40 as may be provided to an individual quick service restaurant during an event. As depicted in user interface 40, information related to an individual quick service restaurant is presented horizontally in a row in the right half of user interface 40. Each row includes values of one or more service metrics and/or information derived therefrom. An informational element 41 includes event information, including the name of the event (“lunch throwdown”), event timing information, and award information (“pizza party for the whole store”). An informational element 42 depicts how much time is left in the current round (“4:48”), and that the current round is round 5 out of 10. An informational element 43 depicts the current ranking order based on the 4 completed rounds of competition, including the top three ranked quick service restaurants, their avatars, and their current scores (which may be based on points that are awarded after each round). Here, the “Arlington” quick service restaurant is ranked first in the ranking order for the entire event, with 56 points scored so far.

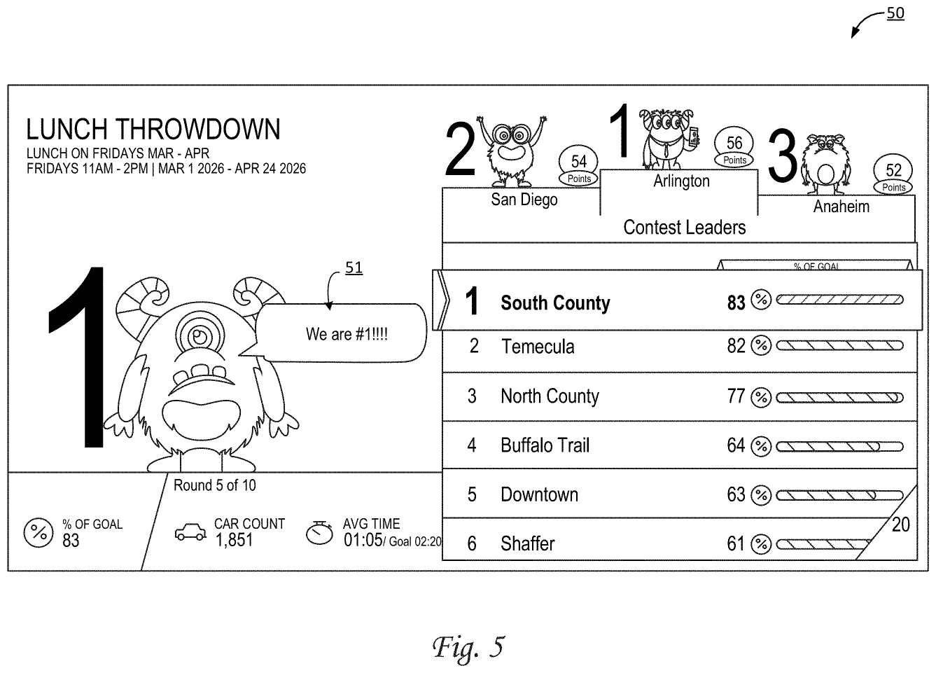

By way of non-limiting example, FIG. 5 illustrates an exemplary user interface 50 as may be provided to an individual quick service restaurant during or upon completion of an event (or a round of an event). As depicted in user interface 50, information related to an individual quick service restaurant is presented horizontally in a row in the right half of user interface 50, similar to user interface 40 in FIG. 4. As depicted in user interface 50, the current round of competition (“round 5 of 10”) may have completed, with the “South County” quick service restaurant being in first place in the ranking order. An informational element 51 provides context-specific and event-specific feedback.

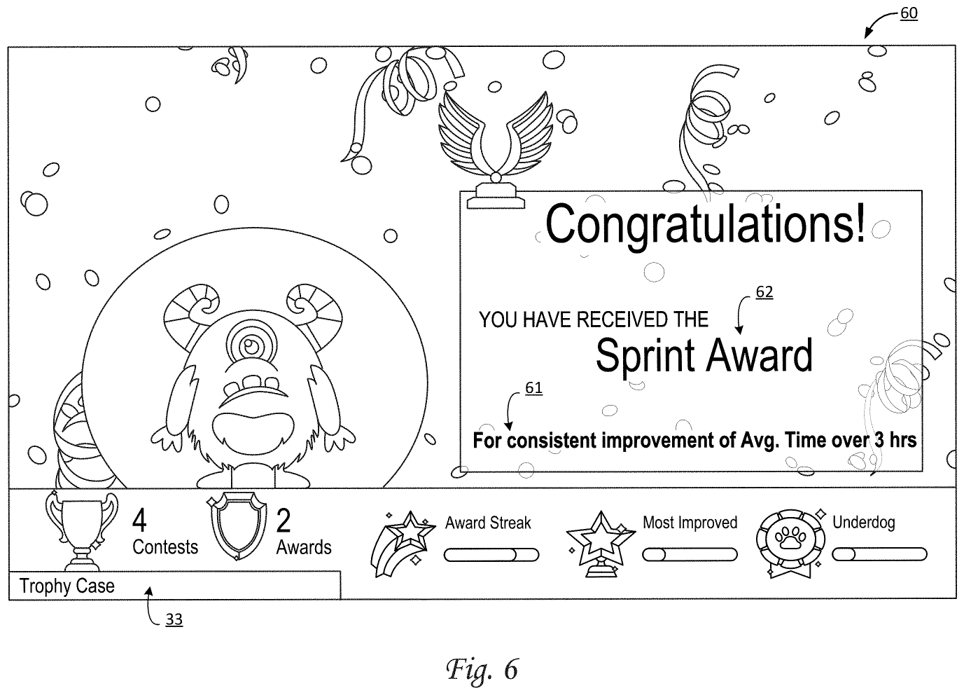

By way of non-limiting example, FIG. 6 illustrates an exemplary user interface 60 as may be provided by system 100 when a quick service restaurant has won an award in an event. As depicted in user interface 60, an informational element 62 describes the name of the award (“Sprint Award”), and an informational element 61 describes the criteria for winning the award (“consistent improvement of average time over 3 hours”). An element 33 depicts a trophy case for an individual quick service restaurant, including information regarding previously awarded awards.

Message component 112 may be configured to create and/or initiate messages. In some implementations, message component 112 may receive, through entry and/or selection by a particular user, a message intended to be included in a particular presentation on a particular user interface. For example, the first user may initiate, create, and/or transfer a first message intended to be presented on the second user interface. For example, the second user may initiate, create, and/or transfer a second message intended to be presented on the first user interface. For example, the third user may initiate, create, and/or transfer a third message intended to be presented on both the first and the second user interfaces. In some implementations, one or both of the content of a particular message and/or the timing (e.g. of transfer) of a particular message (or of a presentation that includes the particular message) may represent a comment on and/or a reaction to a particular prior presentation. For example, a message may include a reaction to a change in the ranking order. For example, a message may include a reaction to the results of an event. In some implementations, messages may have one or more of a limited set of message types. For example, in some implementations, the message types may include taunts, boasts, congratulations, and/or other message types. In some implementations, message component 112 may be configured to prompt a user to initiate and/or transfer a message, e.g., responsive to a change in the ranking order and/or an event-specific result. In some implementations, message component 112 may be configured to recommend a particular message for a user to initiate and/or transfer, e.g., responsive to a change in the ranking order and/or an event-specific result. For example, a recommendation may be based on previous messages by the same user, recent messages received, and/or other context-specific considerations.

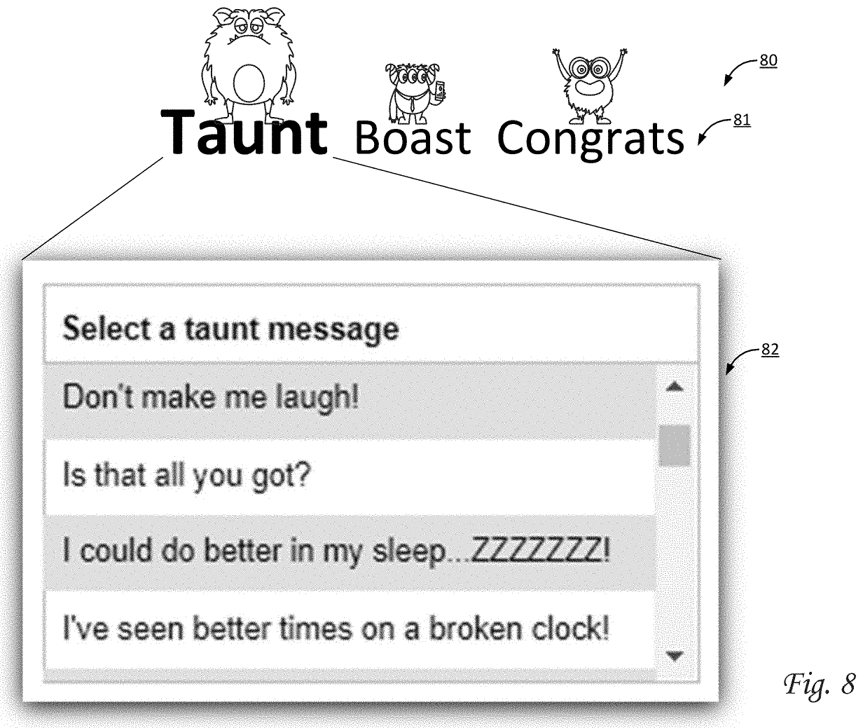

By way of non-limiting example, FIG. 8 illustrates an exemplary user interface 80 as may be provided by system 100 to create a message intended to be included in a particular presentation on a particular user interface. As depicted in user interface 80, an informational element 81 provides a selection for different types of messages. Here, the message types are “taunts,” “boasts,” and “congratulations.” An information element 82 provides a selection of different messages for the selected message type. In some implementations, system 100 may be configured to prompt a user to initiate a message based on the current context, previous messages, and/or event-specific considerations. In some implementations, system 100 may be configured to recommend one or more particular messages based on the current context, previous messages, and/or event-specific considerations.

Referring to FIG. 1, in some implementations, an ability to transfer a message on behalf of a particular quick service restaurant may be blocked and/or prevented unless a check and/or verification indicates a particular performance level of the first quick service restaurant meets a performance level threshold. In some implementations, presentations on user interfaces may include representations that represent progress of the particular performance level towards the particular performance level threshold. In some implementations, such a representation may be referred to as a progress bar. In some implementations, an ability to transfer a message may be limited to authorized users. For example, user may be authorized by authorization component 116. In some implementations, messages may be limited in content, e.g. by selecting from a set of authorized messages.

Message transferring component 114 may be configured to transfer one or more messages to one or more user interfaces. For example, a particular message may be associated with one or more intended recipients. Message transferring component 114 may transfer the particular message to the set of user interfaces that correspond to the intended recipients.

Authorization component 116 may be configured to authorize users to initiate and/or receive communication through the user interfaces on behalf of the quick service restaurants. The users may include a first user authorized to initiate communication through the first user interface on behalf of the first quick service restaurant. Transfer of the first message to the second user interface may be blocked and/or prevented unless a verification indicates the first user is authorized and/or has permission to initiate communication of the first message.

Message receiving component 122 may be configured to obtain and/or receive messages from users and/or user interfaces. In some implementations, message receiving component 122 for the first quick service restaurant may be configured to ignore messages from quick service restaurants that are not part of the same event as the first quick service restaurant.

Layout component 124 may be configured to modify presentations so they include one or more messages. In some implementations, layout component 124 may modify a particular presentation by rearranging elements in the particular presentation to make room for presenting a particular message contemporaneously with the elements in the particular presentation. For example, the elements may be resized or moved around. In some implementations, presentation component 110 may be configured to present a modified presentation on a particular interface. The modified presentation may include the particular message (e.g., a message received by message receiving component 122).

Verification component 126 may be configured to perform verifications. In some implementations, a verification may be used to verify whether a particular user who wishes to communicate a message is authorized to do so and/or otherwise has permission to do so. In some implementations, a verification may be used to verify whether a particular user (or the particular quick service restaurant associated with the particular user) who wishes to communicate a message is allowed to do so in view of the current performance level and/or event-specific result for the particular quick service restaurant. For example, the current performance level may be compared to a performance level threshold as part of a verification. In some implementations, a verification may be used to verify whether the content of a particular proposed message is deemed appropriate to be communicated. For example, verification component 126 may be configured to facilitate manual review of proposed messages.

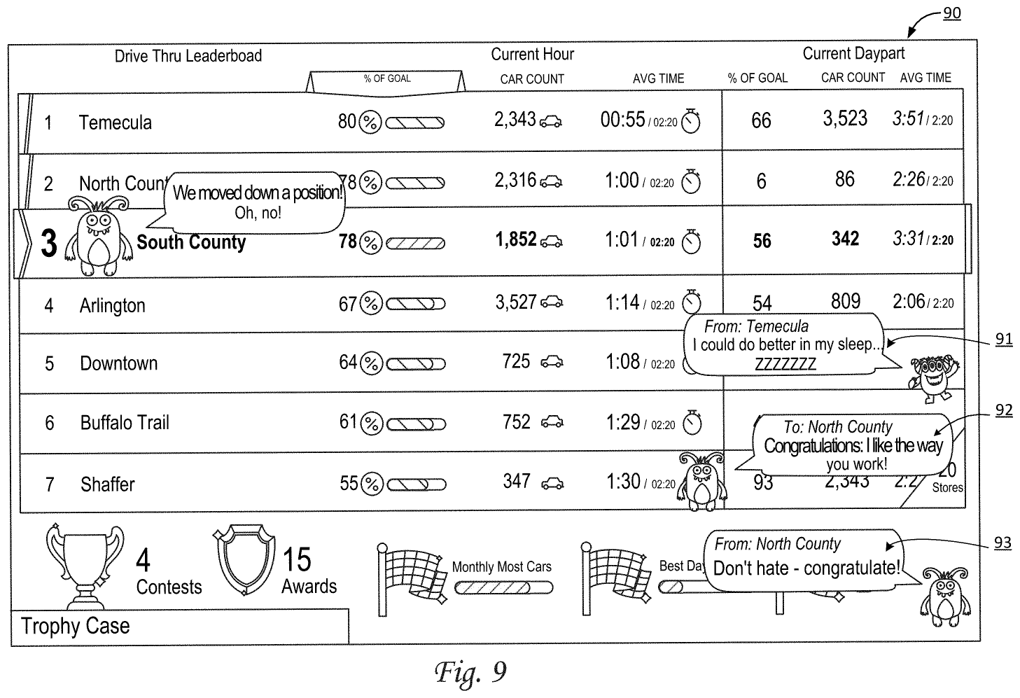

By way of non-limiting example, FIG. 9 illustrates an exemplary user interface 90 as may be presented to provide communication between individual quick service restaurants. As depicted in user interface 90, information related to an individual quick service restaurant is presented horizontally in a row in a manner similar to user interface 30 of FIG. 3. Individual rows may include values of service metrics and/or information derived therefrom, as well as the current status of an event or contest. An informational element 91 may depict a first message from “Temecula” to “South County.” An informational element 92 may depict a second message from “South County” to “North County.” An informational element 93 may depict a third message from “North County” to “South County.” In some implementations, messages between two quick service restaurants may be only visible on the user interfaces of those two quick service restaurants. In some implementations, messages may be visible to most or all quick service restaurants participating in an event.

In some implementations, server(s) 102, client computing platform(s) 104, and/or external resources 128 may be operatively linked via one or more electronic communication links. For example, such electronic communication links may be established, at least in part, via one or more networks 13 such as the Internet and/or other networks. It will be appreciated that this is not intended to be limiting, and that the scope of this disclosure includes implementations in which server(s) 102, client computing platform(s) 104, and/or external resources 128 may be operatively linked via some other communication media.

A given client computing platform 104 may include one or more processors configured to execute computer program components. The computer program components may be configured to enable an expert or user associated with the given client computing platform 104 to interface with system 100 and/or external resources 128, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some implementations, some or all of the functionality attributed herein to external resources 128 may be provided by resources included in system 100.

Server(s) 102 may include electronic storage 130, one or more processors 132, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 122, 124, and/or 126, and/or other components. Processor(s) 132 may be configured to execute components 108, 110, 112, 114, 116, 118, 120, 122, 124, and/or 126, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, 124, and/or 126 are illustrated in FIG. 1 as being implemented within a single processing unit, in implementations in which processor(s) 132 includes multiple processing units, one or more of components 108, 110, 112, 114, 116, 118, 120, 122, 124, and/or 126 may be implemented remotely from the other components. The description of the functionality provided by the different components 108, 110, 112, 114, 116, 118, 120, 122, 124, and/or 126 described below is for illustrative purposes, and is not intended to be limiting, as any of components 108, 110, 112, 114, 116, 118, 120, 122, 124, and/or 126 may provide more or less functionality than is described. For example, one or more of components 108, 110, 112, 114, 116, 118, 120, 122, 124, and/or 126 may be eliminated, and some or all of its functionality may be provided by other ones of components 108, 110, 112, 114, 116, 118, 120, 122, 124, and/or 126. As another example, processor(s) 132 may be configured to execute one or more additional components that may perform some or all of the functionality attributed below to one of components 108, 110, 112, 114, 116, 118, 120, 122, 124, and/or 126.

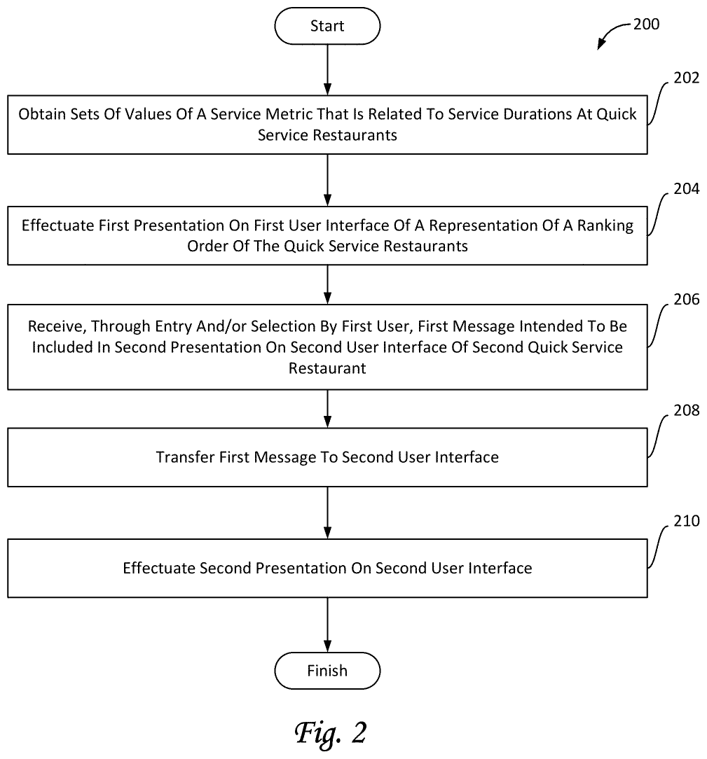

FIG. 2 illustrates a method 200 for providing communication between user interfaces of quick service restaurants, in accordance with one or more implementations. The quick service restaurants may include a first and a second quick service restaurant. The user interfaces may include a first user interface associated with the first quick service restaurant and a second user interface associated with the second quick service restaurant. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining sets of values of a service metric that is related to service durations at the quick service restaurants. The sets of values may be used to determine a ranking order of the quick service restaurants during a time-limited event. Operation 202 may be performed by one or more hardware processors configured by machine-readable instructions including a component that is the same as or similar to metric component 108, in accordance with one or more implementations.

An operation 204 may include effectuating a first presentation on the first user interface of a representation of the ranking order of the quick service restaurants. Operation 204 may be performed by one or more hardware processors configured by machine-readable instructions including a component that is the same as or similar to presentation component 110, in accordance with one or more implementations.

An operation 206 may include receiving, through entry and/or selection by the first user, a first message intended to be included in a second presentation on the second user interface. One or both of content of the first message and/or timing of the second presentation that may include the first message represent a comment on and/or a reaction to the first presentation. Operation 206 may be performed by one or more hardware processors configured by machine-readable instructions including a component that is the same as or similar to message component 112, in accordance with one or more implementations.

An operation 208 may include transferring the first message to the second user interface. Operation 208 may be performed by one or more hardware processors configured by machine-readable instructions including a component that is the same as or similar to message transferring component 114, in accordance with one or more implementations.

An operation 210 may include effectuating the second presentation on the second user interface. The second presentation may include information based on the first message. Operation 210 may be performed by one or more hardware processors configured by machine-readable instructions including a component that is the same as or similar to presentation component 110, in accordance with one or more implementations.

In some implementations, a system as described in this disclosure may be used for customer-oriented businesses that are not quick service restaurants, provided there are defined moments an instance of service being provided starts and ends. Stores, pharmacies, medical offices, and/or other types of customer-oriented businesses may measure service durations and used these measurements to define service metrics and/or other metrics, which may in turn form the basis for the definition of time-limited events, a ranking order, one or more user interfaces similar to the user interfaces described above, one or more awards, and/or any other entity or object described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing communication between user interfaces of quick service restaurants, wherein the quick service restaurants include a first and a second quick service restaurant, wherein the user interfaces include a first user interface associated with the first quick service restaurant and a second user interface associated with the second quick service restaurant, the system comprising:
one or more hardware processors configured by machine-readable instructions to:
obtain sets of values of a service metric that is related to service durations at the quick service restaurants, wherein the sets of values are used to determine a ranking order of the quick service restaurants during a time-limited event;
effectuate a first presentation on the first user interface of a representation of the ranking order of the quick service restaurants;
receive, through entry and/or selection by the first user, a first message intended to be included in a second presentation on the second user interface, wherein one or both of content of the first message and/or timing of the second presentation that includes the first message represent a comment on and/or a reaction to the first presentation; and
transfer the first message to the second user interface, thereby effectuating the second presentation on the second user interface, wherein the second presentation includes information based on the first message.

2. The system of claim 1, wherein the one or more hardware processors are further configured by machine-readable instructions to:
authorize users to initiate and/or receive communication through the user interfaces on behalf of the quick service restaurants, wherein the users include a first user authorized to initiate communication through the first user interface on behalf of the first quick service restaurant, and wherein transferring the first message to the second user interface is blocked and/or prevented unless a verification indicates the first user is authorized to initiate communication of the first message.

3. The system of claim 1, wherein the one or more hardware processors are further configured by machine-readable instructions to:
determine the ranking order of the quick service restaurants during the time-limited event, wherein the determination is based on the obtained sets of values of the service metric.

4. The system of claim 3, wherein the time-limited event is characterized by event timing information, event participant information, and event objective information for the time-limited event;
wherein the event timing information specifies an event start date, an event start time and an event stop time for the time-limited event, thereby defining an event duration between the event start time and the event stop time;
wherein the event participant information identifies individual quick service restaurants participating in the time-limited event;
wherein the event objective information specifies the service metric on which the individual quick service restaurants are competing during the time-limited event, wherein individual ones of the service metrics are based on timing information that represents service durations for individual instances of service being provided during the event duration at the individual quick service restaurants participating in the time-limited event.

5. The system of claim 4, wherein the determination of the ranking order is performed dynamically on an on-going basis throughout the event duration, wherein the representation of the ranking order is updated dynamically and on an ongoing basis such that at most 5 minutes pass between occurrence of a new service duration at the first restaurant and an update to the first presentation.

6. The system of claim 4, wherein the one or more hardware processors are further configured by machine-readable instructions to:
initiate the time-limited event, wherein initiating the time-limited event includes receiving the event information through entry and/or selection by the first user via the first user interface.

7. The system of claim 1, wherein an ability to transfer the first message is blocked and/or prevented unless a verification indicates a first performance level of the first quick service restaurant meets a performance level threshold, wherein the first performance level is based on the first set of values of the service metric.

8. The system of claim 7, wherein the first presentation on the first user interface includes a second representation that represents progress of the first performance level towards the performance level threshold.

9. The system of claim 1, wherein the one or more hardware processors are further configured by machine-readable instructions to:
receive a second message from the second user;
modify the first presentation by rearranging elements in the first presentation to make room for presenting the second message contemporaneously with the elements in the first presentation;
present the modified first presentation on the first interface, wherein the modified first presentation includes the second message.

10. The system of claim 1, wherein the service metric is a percentage of instances of service being provided for which service duration is at or below a service duration goal.

11. A method of providing communication between user interfaces of quick service restaurants, wherein the quick service restaurants include a first and a second quick service restaurant, wherein the user interfaces include a first user interface associated with the first quick service restaurant and a second user interface associated with the second quick service restaurant, the method comprising:
obtaining sets of values of a service metric that is related to service durations at the quick service restaurants, wherein the sets of values are used to determine a ranking order of the quick service restaurants during a time-limited event;
effectuating a first presentation on the first user interface of a representation of the ranking order of the quick service restaurants;
receiving, through entry and/or selection by the first user, a first message intended to be included in a second presentation on the second user interface, wherein one or both of content of the first message and/or timing of the second presentation that includes the first message represent a comment on and/or a reaction to the first presentation; and
transferring the first message to the second user interface, and thereby effectuating the second presentation on the second user interface, wherein the second presentation includes information based on the first message.

12. The method of claim 11, further comprising:
authorizing users to initiate and/or receive communication through the user interfaces on behalf of the quick service restaurants, wherein the users include a first user authorized to initiate communication through the first user interface on behalf of the first quick service restaurant, and wherein transferring the first message to the second user interface is blocked and/or prevented unless a verification indicates the first user is authorized to initiate communication of the first message.

13. The method of claim 11, further comprising:
determining the ranking order of the quick service restaurants during the time-limited event, wherein the determination is based on the obtained sets of values of the service metric.

14. The method of claim 13, wherein the time-limited event is characterized by event timing information, event participant information, and event objective information for the time-limited event;
wherein the event timing information specifies an event start date, an event start time and an event stop time for the time-limited event, thereby defining an event duration between the event start time and the event stop time;
wherein the event participant information identifies individual quick service restaurants participating in the time-limited event;
wherein the event objective information specifies the service metric on which the individual quick service restaurants are competing during the time-limited event, wherein individual ones of the service metrics are based on timing information that represents service durations for individual instances of service being provided during the event duration at the individual quick service restaurants participating in the time-limited event.

15. The method of claim 14, wherein the determination of the ranking order is performed dynamically on an on-going basis throughout the event duration, wherein the representation of the ranking order is updated dynamically and on an ongoing basis such that at most 5 minutes pass between occurrence of a new service duration at the first restaurant and an update to the first presentation.

16. The method of claim 14, further comprising:
initiating the time-limited event, wherein initiating the time-limited event includes receiving the event information through entry and/or selection by the first user via the first user interface.

17. The method of claim 11, wherein an ability to transfer the first message is blocked and/or prevented unless a verification indicates a first performance level of the first quick service restaurant meets a performance level threshold, wherein the first performance level is based on the first set of values of the service metric.

18. The method of claim 17, wherein the first presentation on the first user interface includes a second representation that represents progress of the first performance level towards the performance level threshold.

19. The method of claim 11, further comprising:
receiving a second message from the second user;
modifying the first presentation by rearranging elements in the first presentation to make room for presenting the second message contemporaneously with the elements in the first presentation; and
presenting the modified first presentation on the first interface, wherein the modified first presentation includes the second message.

20. The method of claim 11, wherein the service metric is a percentage of instances of service being provided for which service duration is at or below a service duration goal.
